(19) United States
(12) Patent Application Publication
(10) Pub. No.: US 2012/0296741 A1
(43) Pub. Date: Nov. 22, 2012

(54) CLOUD BASED ELECTRONIC WALLET

(75) Inventor: Robert DYKES, San Jose, CA (US)

(73) Assignee: VERIFONE, INC., San Jose, CA (US)

(21) Appl. No.: 13/468,686

(22) Filed: May 10, 2012

Related U.S. Application Data
(60) Provisional application No. 61/487,787, filed on May 19, 2011.

(51) Int. Cl. G06Q 20/20; G06Q 30/02

(52) U.S. Cl. 705/14.53; 705/16

(57) ABSTRACT

A payment system including a transaction server, a virtual wallet server (VWS), at least one point of sale device including a secure element and being operative to provide secure data communication of a purchaser wallet personal identification number (WPIN), but not purchaser payment particulars, to at least the VWS and at least one mobile communicator communicating a mobile communicator presence indicator (MCPI) but neither the purchaser WPIN nor the purchaser payment particulars to the at least one point of sale device.

### REFERENCE TO RELATED APPLICATIONS

Reference is hereby made to U.S. Provisional Patent Application Ser. No. 61/487,787, filed May 19, 2011 and entitled CLOUD BASED ELECTRONIC WALLET, the disclosure of which is incorporated by reference in its entirety and priority of which is hereby claimed pursuant to 37 CFR 1.78(a) (4) and (5)(i).

### FIELD OF THE INVENTION

The present invention relates to payment systems and methodologies generally and more particularly to electronic wallet payment systems.

### BACKGROUND OF THE INVENTION

The following patent publications are believed to represent the current state of the art:

U.S. Patent Publication Nos. US2006/0253335; US2009/0104888; US2008/0048022; US2005/0071179 and US2002/0077993;

Published PCT Application No. WO08104704; and

Patent Publication Nos. TW200515229; CN101499190; KR20020004321 and TW200813871.

### SUMMARY OF THE INVENTION

The present invention seeks to provide improved payment systems and methodologies.

There is thus provided in accordance with a preferred embodiment of the present invention a payment system including a transaction server, a virtual wallet server (VWS), at least one point of sale device including a secure element and being operative to provide secure data communication of a purchaser wallet personal identification number (WPIN), but not purchaser payment particulars, to at least the VWS and at least one mobile communicator communicating a mobile communicator presence indicator (MCPI) but neither the purchaser WPIN nor the purchaser payment particulars to the at least one point of sale device.

Preferably, the at least one mobile communicator stores neither the purchaser WPIN nor the purchaser payment particulars. In accordance with a preferred embodiment of the present invention the at least one mobile communicator neither reads, writes, communicates nor stores either the purchaser WPIN or the purchaser payment particulars. Additionally or alternatively, the at least one point of sale device is capable of receiving the purchaser WPIN at the secure element and receiving the MCPI for card presence verification for carrying out a card present transaction with the VWS.

Preferably, the payment system also includes at least one customer purchases information (CPI) database containing customer-wise information regarding customer purchases and at least one customer-wise purchase proposal generation device (CPPGD) in data communication with the at least one CPI database, the at least one CPPGD including a customer-wise information interface (CWII) receiving from the at least one CPI database the customer-wise information regarding customer purchases, a customer-wise products not purchased calculator (CWPPC) operative to ascertain the identity of at least one product which is normally purchased by customers and which is not usually purchased by a specific customer from a given sales entity and a purchase proposal generation engine (PPGE) generating an individualized purchase proposal for the at least one product which is normally purchased by customers and which is not usually purchased by the specific customer from the given sales entity to the specific customer based on the customer-wise information regarding customer purchases.

In accordance with a preferred embodiment of the present invention the VWS is operative in conjunction with a plurality of payment modalities and is operative to automatically select one of the plurality of payment modalities for a given transaction, based on at least identity of a customer and identity of a merchant.

Preferably, the VWS is operative in conjunction with a plurality of payment modalities and the at least one point of sale device provides to the VWS at least data identifying a specific merchant and a specific purchase, the VWS being operative prior to completion of a specific transaction to recommend to a customer about to complete the transaction one of the plurality of payment modalities for the specific transaction between the specific merchant and a specific customer for the specific purchase at a specific time; based on at least one of identity of the specific customer, identity of the specific merchant, particulars of the specific purchase and the time.

There is also provided in accordance with another preferred embodiment of the present invention a payment system including a transaction server, a virtual wallet server (VWS), at least one point of sale device including a secure element and being operative to provide secure data communication of a purchaser wallet personal identification number (WPIN) to at least the VWS and at least one mobile communicator communicating at least one mobile communicator presence indicator (MCPI) but storing neither the purchaser WPIN nor the purchaser payment card number.

There is further provided in accordance with yet another preferred embodiment of the present invention a payment system including a transaction server, a virtual wallet server (VWS), at least one point of sale device including a secure element and being operative to provide secure data communication of a purchaser wallet personal identification number (WPIN) to at least the VWS and at least one mobile communicator communicating at least one mobile communicator presence indicator (MCPI) but neither reading, writing, communicating nor storing either the purchaser WPIN or the purchaser payment card number.

There is also provided in accordance with still another preferred embodiment of the present invention a payment system including a virtual wallet server (VWS), at least one point of sale device including a secure element enabling secure data communication with the VWS and at least one mobile communicator capable of communicating a mobile communicator presence indicator (MCPI) to the at least one point of sale device, the at least one point of sale device being capable of receiving a purchaser identifier at the secure element and receiving the MCPI for card presence verification for carrying out a card present transaction with the VWS.

Preferably, the at least one mobile communicator does not require a secure element for communicating the MCPI.

In accordance with a preferred embodiment of the present invention the at least one mobile communicator does not include a secure element for communicating the MCPI.

In accordance with a preferred embodiment of the present invention the MCPI includes at least one of a user selected identifier, a phone number of the at least one mobile communicator, an international mobile subscriber identity (IMSI) of the at least one mobile communicator, an international mobile equipment identity (IMEI) of the at least one mobile communicator and a randomly generated temporary mobile subscriber identity (TMSI) of the at least one mobile communicator.

In accordance with a preferred embodiment of the present invention the TMSI is received by and stored in the mobile communicator. Additionally, the TMSI is received by the mobile communicator from the VWS via a wireless system.

There is even further provided in accordance with yet another preferred embodiment of the present invention a customer identity and product identity offer generation system including at least one customer purchases information (CPI) database containing customer-wise information regarding customer purchases and at least one customer-wise purchase proposal generation device (CPPGD) in data communication with the at least one CPI database, the at least one CPPGD including a customer-wise information interface (CWII) receiving from the at least one CPI database the customer-wise information regarding customer purchases, a customer-wise products not purchased calculator (CWPPC) operative to ascertain the identity of at least one product which is normally purchased by customers and which is not usually purchased by a specific customer from a given sales entity and a purchase proposal generation engine (PPGE) generating an individualized purchase proposal for the at least one product which is normally purchased by customers and which is not usually purchased by the specific customer from the given sales entity to the specific customer based on the customer-wise information regarding customer purchases.

There is still further provided in accordance with still another preferred embodiment of the present invention a payment system including a virtual wallet server (VWS) operative in conjunction with a plurality of payment modalities and at least one point of sale device in data communication with the VWS and providing at least data identifying a specific merchant and a specific purchase, the VWS being operative prior to completion of a specific transaction to recommend to a customer about to complete the transaction one of the plurality of payment modalities for the specific transaction between the specific merchant and a specific customer for the specific purchase at a specific time; based on at least one of identity of the specific customer, identity of the specific merchant, particulars of the specific purchase and the time.

### BRIEF DESCRIPTION OF THE DRAWINGS

The present invention will be understood and appreciated more fully from the following detailed description, taken in conjunction with the drawings in which:

FIGS. 1A-1D are simplified pictorial illustrations of the operation of a payment system constructed and operative in accordance with a preferred embodiment of the present invention;

FIG. 2 is a simplified flowchart illustrating a virtual wallet set up procedure in the operation of the payment system of an embodiment of the present invention;

FIG. 3A-3C are together a simplified flowchart illustrating operation of the payment system of an embodiment of the present invention; and

FIG. 4 is a simplified flowchart illustrating automatic generation of recommendations in accordance with an embodiment of the present invention.

### DETAILED DESCRIPTION OF A PREFERRED EMBODIMENT

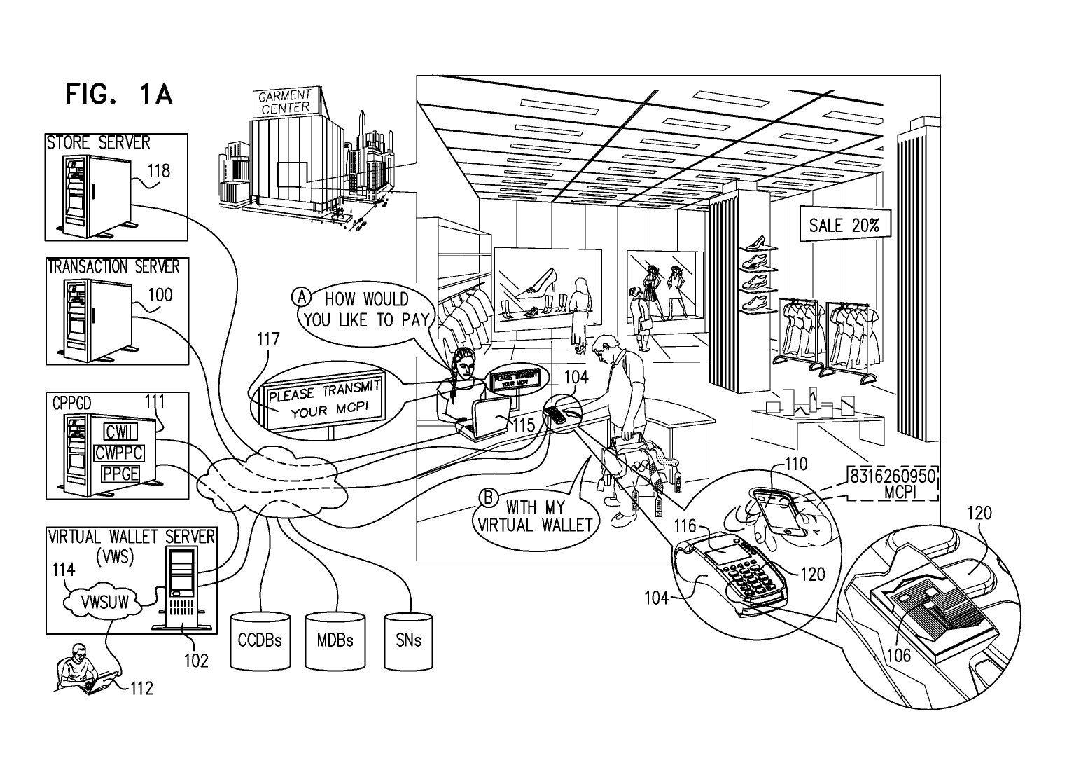

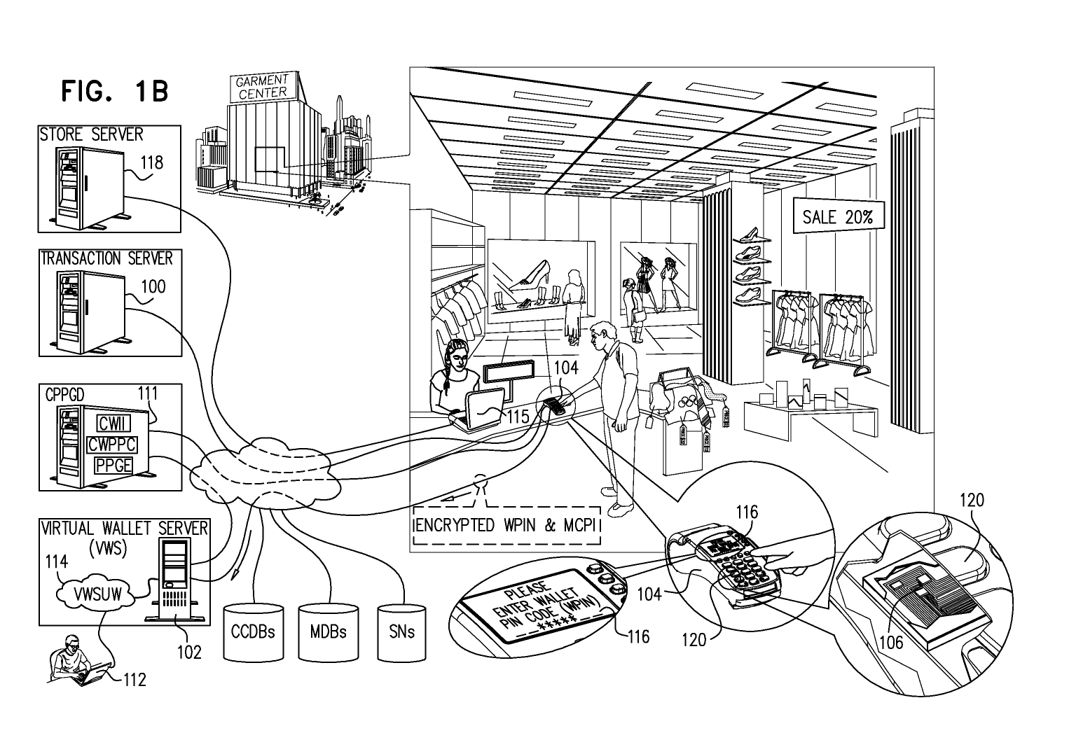

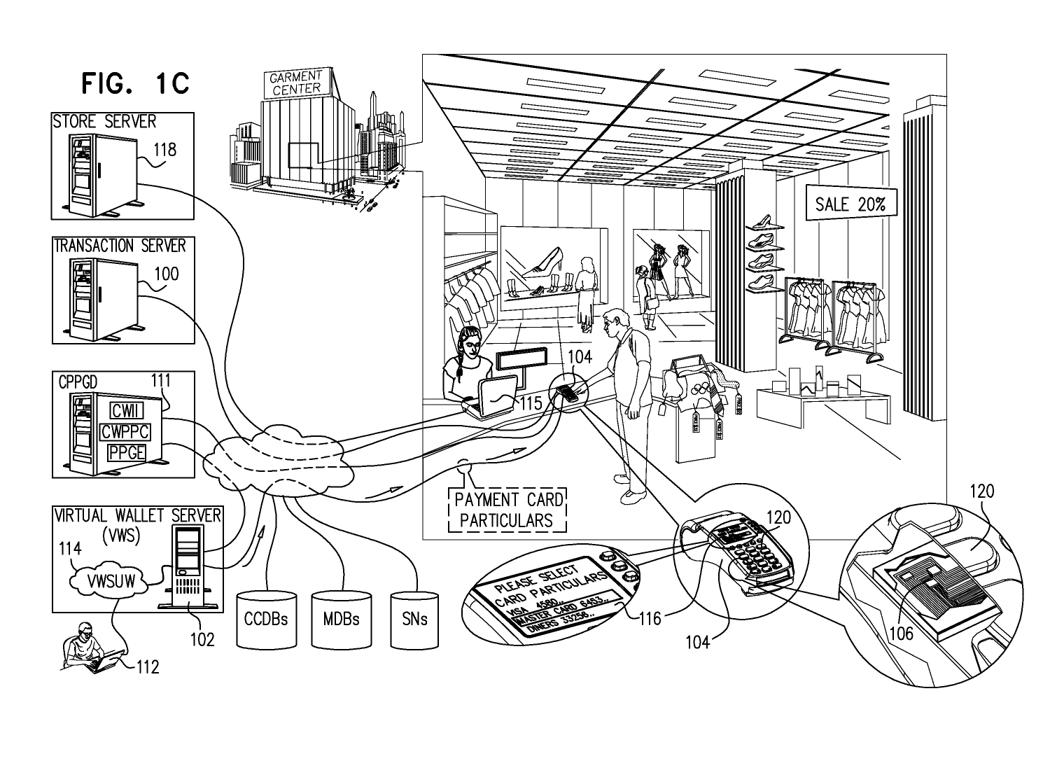

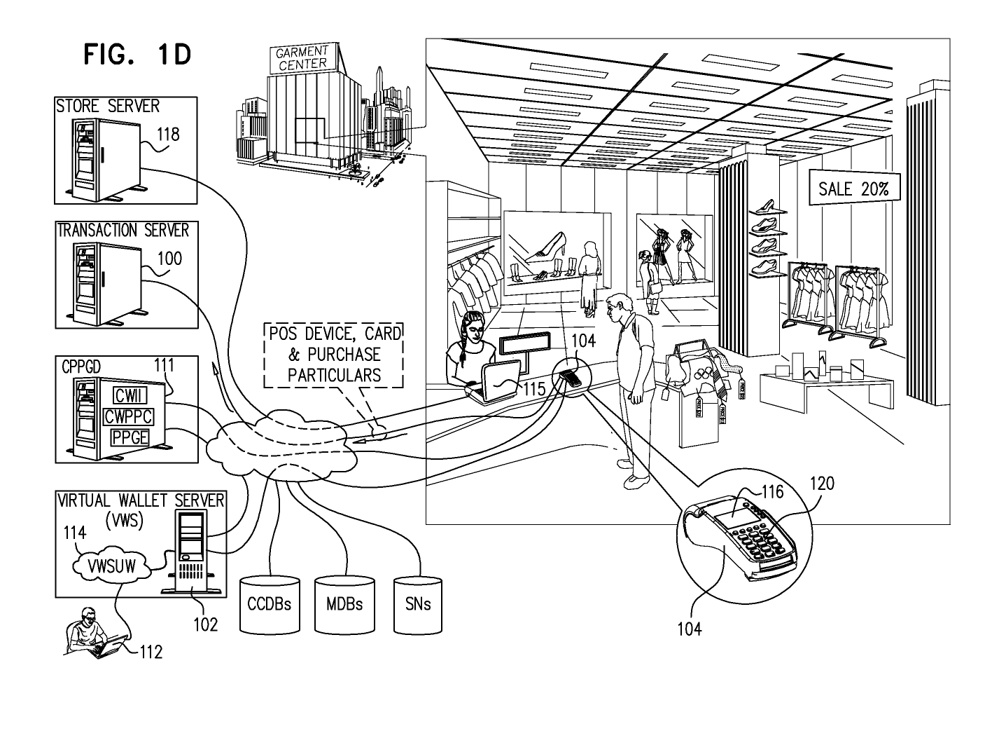

Reference is now made to FIGS. 1A-1D, which are pictorial illustrations of the operation of a virtual wallet payment system constructed and operative in accordance with a preferred embodiment of the present invention. The payment system preferably includes a transaction server 100, which is operative for conducting conventional payment card transactions, such as credit card, debit card and prepaid card transactions, and a virtual wallet server (VWS) 102, which stores at least payment card information of virtual wallet subscribers.

At least one point of sale device 104, such as a Verifone PINPad 1000SE, includes a secure element 106, for storage therein of confidential data, and is operative to provide secure data communication of at least a purchaser wallet PIN (WPIN), such as an encrypted WPIN, to at least VWS 102 and possibly also to transaction server 100. It is a particular feature of an embodiment of the present invention that the point of sale device 104 does not transmit a purchaser payment card number to the VWS 102.

At least one mobile communicator 110, such as a cellular telephone, which may or may not be Near Field Communications (NFC)-enabled, communicates a mobile communicator presence indicator (MCPI) to the point of sale device 104. In a preferred embodiment of the present invention, the MCPI includes at least one of, or a combination of, a user selected identifier, the telephone number of mobile communicator 110, an international mobile subscriber identity (IMSI) of mobile communicator 110, an International Mobile Equipment Identity (IMEI) number of mobile communicator 110, and a single-use key, such as a Temporary Mobile Subscriber Identity (TMSI) or another key that has been sent, for example, via a text message, to the mobile communicator 110 or to an application on the mobile communicator 110.

In the illustrated embodiment of FIG. 1A, both the mobile communicator 110 and the point of sale device 104 are shown to be NFC-enabled. It is a particular feature of the present invention that the mobile communicator 110 does not communicate either a purchaser WPIN or a purchaser payment card number to a point of sale device 104. Accordingly, mobile communicators which do not have a secure element 106, or where the secure element is not accessible, may be used for this purpose.

In a preferred embodiment of the present invention, the MCPI is transmitted to the point of sale device 104 and communicated from the point of sale device 104 to the VWS 102. When the MCPI includes a single-use key, the single-use key is preferably generated using Rolling Code Encryption (RCE).

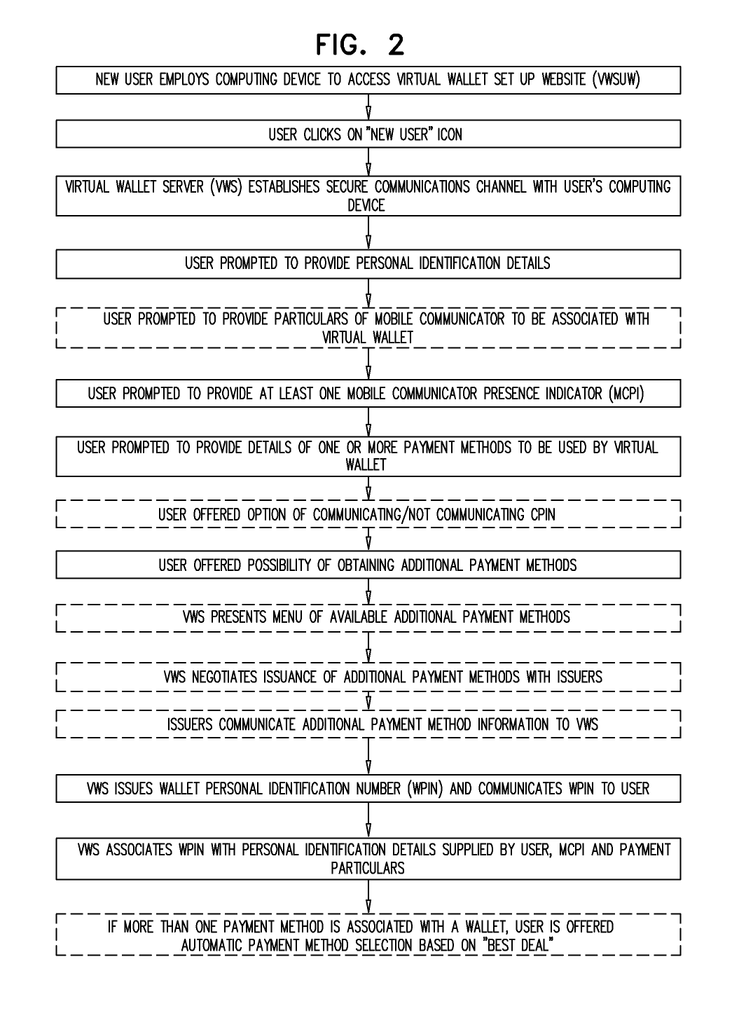

Reference is now made additionally to FIG. 2, which is a simplified flowchart illustrating a virtual wallet set up procedure, which takes place prior to a purchase using the system depicted in FIGS. 1A-1D.

Turning to FIG. 2, it is seen that preferably a user employs his mobile communicator 110, or another computing device, such as a home computer 112, to access a virtual wallet set up website (VWSUW) 114, which is hosted by, or communicates with, VWS 102. Alternatively, a suitably programmed point of sale device 104 may also be used to access virtual wallet set up website (VWSUW) 114.

A new user typically starts a registration procedure by clicking on a ‘NEW USER’ icon. In response, VWS 102 establishes a secure communications channel with the user's mobile communicator 110 or another computing device employed by the user.

The user is then prompted to provide personal identification details, such as full name, mailing address, e-mail address and government issued identification, and, preferably, to provide particulars of the mobile communicator 110 which is intended to be used to operate the wallet. Alternatively, the wallet need not be associated with any given mobile communicator 110.

The user is also prompted to provide at least one mobile communicator presence indicator (MCPI) to be transmitted by the user's mobile communicator 110 to a point of sale device 104 in order to operate the virtual wallet in a purchase transaction. Preferably, the MCPI includes one or more of a user selected identifier, a telephone number of the mobile communicator 110, an international mobile subscriber identity (IMSI) of mobile communicator 110, an international mobile equipment identity (IMEI) of mobile communicator 110 and a temporary mobile subscriber identity (TMSI) of mobile communicator 110. Alternatively, the MCPI may be any other suitable identifier, which can be communicated from the user's mobile communicator 110 to the point of sale device 104.

The user is then prompted to provide details of one or more modalities, typically payment cards, such as credit cards, debit cards and prepaid cards, or financial accounts, such as a bank account and an on-line payment account, to be used by the virtual wallet. Such details, hereinafter termed purchase payment particulars (PPP), preferably include the card number, expiration date and card specific PIN (CPIN), if such exists, or ID of the bank or financial institution and the bank account or financial account number. CPINs are typically required for using debit cards. It is appreciated that a user may be given the option not to communicate a CPIN to the VWS during set up. In such a case, the user may communicate the CPIN by entering it onto a PINpad of a point of sale device in the course of a future purchase transaction.

The user may then be offered the possibility of obtaining one or more additional payment cards or access to other payment methods. In such a case, the user may be presented with a menu showing the available payment cards and the conditions associated with each. Should a user express interest in obtaining one or more additional cards, the VWS 102, using the personal identification details of the user, may negotiate issuance of such payment cards with the servers of the issuers via secure communication links. Upon issuance, the servers of the issuers communicate in a secure manner the card numbers and the CPINs, to the extent that they exist, to the VWS 102. Preferably, at least the CPINs are communicated and stored in an encrypted form. It is a particular feature of this embodiment of the present invention that neither the full card numbers nor the CPINs are communicated to the user.

In accordance with a preferred embodiment of the present invention, the VWS 102 issues a wallet personal identification number (WPIN), which is communicated to the user in a conventional manner, suitable for communicating PIN numbers, such as by email or conventional mail.

At the VWS 102, for each wallet an association is created between the WPIN, the personal identification details supplied by the user during set up, the MCPI and the particulars of one or more payment cards, such as card number and expiration date, as well as any CPIN or ID of the bank or financial institution and the bank account or financial account number. This associated data is preferably stored in an encrypted form at the VWS 102. The CPINs are normally required to be stored in encrypted form.

When more than one card is associated with a given wallet, the customer is further offered the option to agree in advance to automatic card selection by VWS 102 in a purchase transaction, based on the “best deal” available for that specific customer for the given purchase, as ascertained at or near the time of the purchase by the VWS 102.

It is appreciated that the customer may add, delete and change virtual wallet parameters via the VWSUW 114 at any time following the set up procedure. These parameters may include designation of the cards associated with his wallet, his MCPI and various other particulars of his wallet.

A registered user typically starts a virtual wallet parameter modification procedure by clicking on a ‘REGISTERED USER’ icon. In response, VWS 102 establishes a secure communications channel with the user's mobile communicator 110 or another computing device employed by the user.

The user downloads a “mobile wallet” application into his mobile communicator 110 and may initialize the “mobile wallet” application by inserting his MCPI. The user may be requested to indicate if his MCPI is his mobile phone number. The MCPI may be stored in the memory of mobile communicator 110. If the MCPI is the telephone number or IMEI number of the mobile communicator 110 it may be retrieved directly from the SIM card or operating system of the mobile communicator operator.

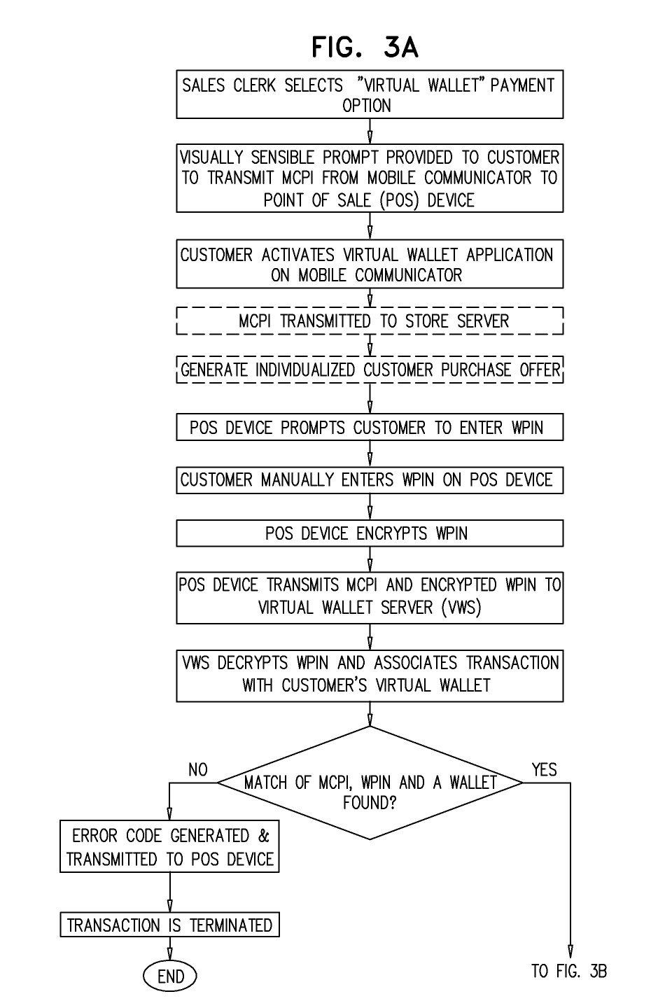

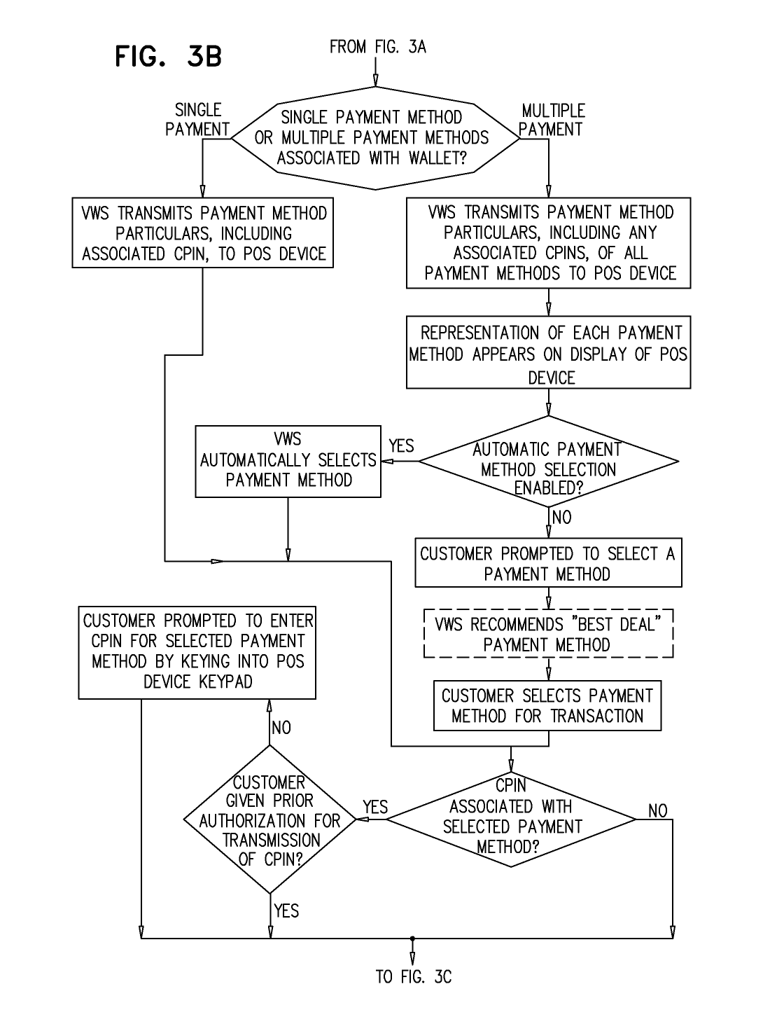

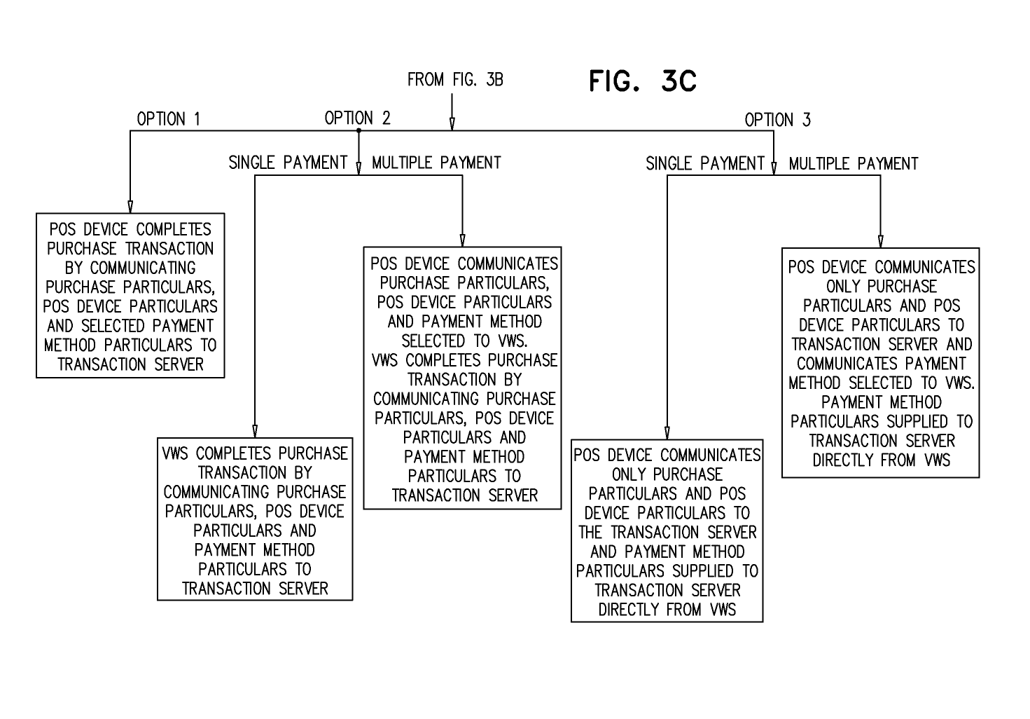

Returning now to FIGS. 1A-1D, a typical purchase transaction using the system and methodology of embodiments of the present invention is now described with additional reference to FIGS. 3A-3C. It is seen that once a customer's purchases are rung up on a cash register 115, a sales clerk asks the customer how he wishes to pay. If the customer answers “with my virtual wallet”, the sales clerk or customer selects a payment option, here termed “virtual wallet,” from a menu on the cash register 115 and/or the point of sale device 104. Selection of the “virtual wallet” payment option causes a visually sensible prompt to the customer to appear on a display 116 on the point of sale device 104 and/or on a display 117 of the cash register 115. The prompt requests that the customer transmit an MCPI from the mobile communicator 110 to the point of sale device 104 or, alternatively, to enter an MCPI, that may be provided by the mobile communicator 110, on a keypad of the point of sale device 104. The customer activates his virtual wallet application on his mobile communicator 110, which preferably retrieves or has previously retrieved the MCPI. It is appreciated that when the MCPI includes a single-use key, the application, after using the single-use key, preferably retrieves a new single-use key for future use. The MCPI may be transmitted to a store server 118 to enable personalized generation of a personalized welcome message and/or other personalized messages or promotions to the customer at the point of sale device 104 or on mobile communicator 110, on the basis of predefined associations between the MCPI and the customer.

As also seen in FIG. 1A, in accordance with a preferred embodiment of the present invention, there is provided at least one customer-wise purchase proposal generation device (CPPGD) 111, preferably in data communication with VWS 102. Alternatively, the at least one customer-wise purchase proposal generation device may be embodied in VWS 102. In another preferred embodiment of the present invention, at least one CPPGD 111 may be in data communication with POS device 104 independent of VWS 102 and VWS 102 may be obviated. CPPGD 111 is operative to generate at least one individualized purchase proposal for presentation to the customer at the time of completing a purchase.

The at least one CPPGD 111 preferably is in communication with at least one customer purchases information (CPI) database, such as a commercial credit database (CCDB), a merchant database (MDB) and a social network (SN), including information regarding the customer's buying habits, such as previous customer purchases history. The CPPGD 111 preferably provides offers to the customer via the point of sale device 104. Such offers may include purchase offers based on the information regarding the customer's buying habits and specifically may include offers to purchase goods which the customer is known to purchase but does not currently purchase from the merchant at which the customer is currently making a purchase.

The CPPGD preferably includes a customer-wise information interface (CWII), a customer-wise products not purchased calculator (CWPPC) and a purchase proposal generation engine (PPGE). The CWII preferably receives information regarding customer buying habits, typically including at least information regarding previous product purchases by the customer, from the at least one CPI database. The CWPPC is preferably operative to ascertain the identity of at least one product which is normally purchased by other customers and which is not usually purchased by this customer from the sales entity the customer is currently purchasing from. The PPGE preferably generates an individualized purchase proposal to the customer for the at least one product identified by the CWPPC.

It is appreciated that communication of the MCPI to the point of sale device 104 may take place prior to, during or following tallying of a customer's purchases.

In a case where the MCPI is transmitted by the mobile communicator 110, the transmission may be effected by the user placing his mobile communicator 110 on or in close proximity to an NFC (Near Field Communication) enabled point of sale device 104 or other NFC communication location associated with the point of sale device 104 and/or the cash register 115.

It is a particular feature of the present invention that, for transactions not requiring a CPIN, receipt of the MCPI at the point of sale device 104, together with the user entering the WPIN, may constitute an acceptable indication of customer presence which enables a transaction to be considered as being a “card-present” transaction.

It is a particular feature of the present invention that, for transactions requiring a CPIN, receipt of the MCPI at the point of sale device 104, together with the user entering the CPIN and the WPIN, may constitute an acceptable indication of customer presence which enables a transaction to be considered as being a “card-present” transaction.

Communication of the MCPI to the point of sale device 104 may be via one of a number of communication links, such as BLUETOOTH®, WiFi, optical and cellular, or the MCPI may be entered manually. A preferred method of optical communication is described in assignee's U.S. patent application Ser. No. 13/006,137, entitled Light Based and Online Payment Systems and Methodologies, filed Jan. 13, 2011.

As seen in FIG. 1B, upon receipt of the MCPI the point of sale device 104 prompts the customer to enter his WPIN by keying onto a secure keypad 120 of the point of sale device 104. It is a particular feature of the present invention that the WPIN is entered manually by the customer onto the point of sale device 104. This feature obviates the need for the mobile communicator 110 to have a secure element and to provide a secure communications link with the mobile communicator 110.

The customer manually enters his WPIN on the point of sale device 104. The point of sale device 104 preferably encrypts the WPIN. The point of sale device 104 preferably transmits, preferably in a single secure session, such as an SSL session, the MCPI and the encrypted WPIN to the VWS 102.

The VWS 102 decrypts the WPIN and, using the MCPI, associates the proposed transaction with the virtual wallet of the customer. If the VWS 102 does not find a match of the MCPI and the WPIN with a specific wallet, an error code is generated and transmitted by the VWS 102 to the point of sale device 104, and the transaction is terminated.

If a match of the MCPI and the WPIN and a specific wallet is found, the transaction proceeds.

If only a single payment modality is associated with the given wallet, such as a single payment card, the VWS 102 transmits the purchase payment particulars, such as payment card particulars, including the payment card number and its expiration date, to the point of sale device 104. One or more, or all of, the purchase payment particulars may be transmitted in encrypted form. If a CPIN is associated with a given payment card and the customer has given prior authorization for the CPIN to be automatically provided, the CPIN is also transmitted, preferably in encrypted form, to the point of sale device 104. Optionally, the transmission of purchase payment particulars takes place in a secure session.

As seen in FIG. 1C, if multiple payment modalities, such as multiple payment cards, are associated with a given wallet, the VWS 102 transmits to the point of sale device 104 the purchase payment particulars of all such payment cards, including the payment card number and its expiration date. One or more, or all of, the payment card particulars may be transmitted in encrypted form. If a CPIN is associated with a given payment card, the CPIN is also transmitted, preferably in encrypted form, to the point of sale device 104. Optionally, the transmission of purchase payment particulars, such as payment card particulars, takes place in a secure session.

As also seen in FIG. 1C, when multiple payment cards are associated with a given wallet, a representation of each of the cards appears, preferably on a display 116 of the point of sale device 104. The representation preferably includes the logo of the payment card company. Additionally, the logo or other details of the issuer and/or the last four digits of the card number may also be included in the representation. The customer is prompted to select one of the cards.

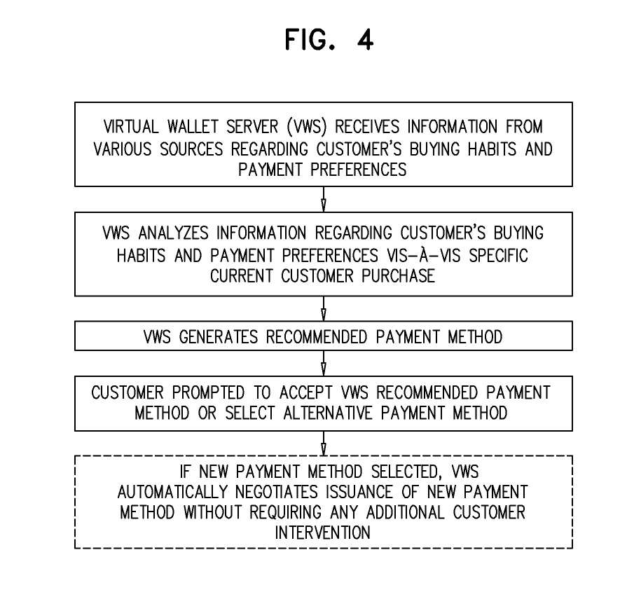

In accordance with an embodiment of the present invention, at the time of presentation to the customer of the various payment cards that can be used for the transaction, a recommendation may be automatically made to the customer as to which payment card or cards provides the “best deal”. The automatic provision of a recommendation normally requires prior authorization from the customer, which is normally given at the time of set up or in a subsequent modification session. The “best deal” may represent one or more of discounts, payment terms, coupons, points and other customer benefits. Automatic generation of a recommendation is described hereinbelow with respect to FIG. 4.

As seen in FIG. 1C, the customer is prompted to select a payment card and selects a payment card with which to effect the purchase transaction or alternatively, based on a prior customer agreement in the wallet setup procedure, the system may automatically select the payment card to be used in the transaction.

If a CPIN is associated with the selected payment card and the customer has not given prior authorization for transmission thereof, the customer is prompted to enter the CPIN for the selected payment card by keying it onto the secure keypad 120 of the point of sale device 104.

As seen in FIG. 1D, the point of sale device 104 then completes the purchase transaction in a conventional manner by communicating purchase particulars, such as the amount and date of the transaction, particulars of the point of sale device 104, such as the identification number of the point of sale device 104, and the payment purchase particulars (PPP) of the selected payment card to the transaction server 100.

Where a CPIN is associated with the selected payment card, the CPIN is decrypted at the point of sale device 104 and is re-encrypted for secure transmission to the transaction server 100.

Alternatively, if a single payment card is associated with the virtual wallet, the virtual wallet server 102 may complete the purchase transaction in a conventional manner by communicating to the transaction server 100 purchase particulars, such as the amount and date of the transaction, particulars of the point of sale device 104, such as the identification number of the point of sale device 104, and the particulars of the selected payment card.

Alternatively, if a single payment card is associated with the virtual wallet, the point of sale device 104 may communicate only the purchase particulars and the particulars of the point of sale device 104 to the transaction server 100 and the particulars of the single payment card are supplied to the transaction server 100 directly from the virtual wallet server 102.

Alternatively, if multiple payment modalities, such as multiple payment cards and/or bank accounts, are associated with the virtual wallet, the point of sale device 104 may communicate to the virtual wallet server 102 the purchase particulars and the particulars of the point of sale device 104 and the customer's selection of payment modality, such as payment card. The virtual wallet server 102 may complete the purchase transaction in a conventional manner by communicating to the transaction server 100 purchase particulars, such as the amount and date of the transaction, particulars of the point of sale device 104, such as the identification number of the point of sale device 104, and the payment purchase particulars of the selected payment card.

Alternatively if multiple payment modalities, such as multiple payment cards and/or bank accounts, are associated with the virtual wallet, the point of sale device 104 may communicate only the purchase particulars and the particulars of the point of sale device 104 to the transaction server 100 and may communicate the customer's selection of payment card or bank account to the virtual wallet server 102. The purchaser payment particulars are supplied to the transaction server 100 directly from the virtual wallet server 102.

Reference is now made to FIG. 4, which is a simplified flowchart illustrating automatic generation of a recommendation as to which of a plurality of payment cards or direct charge to a bank account is most advantageous for the customer in a given transaction, thereby providing the “best deal” for the customer. Based on prior authorization from the customer, the VWS 102 may employ information received from various sources, including for example, commercial credit databases (CCDBs), merchants databases (MDBs) and social networks (SNs) regard the customer's buying habits and payment preferences.

The recommendation may be to use one of the payment cards or bank accounts that the customer currently holds. Alternatively, the recommendation may be to use a payment card that the customer does not currently hold, but which he is eligible to obtain.

The recommendation is preferably generated by utilizing at least one of the identity of the customer, the identity of the merchant, the information relating to the specific purchase and the time. Specifically, the recommendation may be based on at least one of information relating to the customer, such as the customer's payment history, information relating to the merchant, such as merchant or payment method discounts currently available using preferred payment options and the information relating to the specific purchase, such as currently available product promotional offers.

The customer is prompted to accept the recommendation or choose an alternative payment method. If the customer accepts a recommendation to obtain a new payment method, such as a new payment card or new financial account, the VWS 102 is preferably operative automatically to negotiate issuance of the new payment card or financial account, preferably without requiring any further intervention of the user. For this purpose, the VWS 102 may be required to divulge personal information of the customer and accordingly, the customer's agreement is solicited preferably at the set up stage of system operation.

It is a particular feature of the present invention that the purchaser's payment particulars, and specifically payment card number, are not communicated from the point of sale device 104 to the VWS 102 in a virtual wallet transaction. It is a particular feature of the present invention that the purchaser's payment particulars, and specifically payment card number, are also not communicated by the mobile communicator 110 to any of the point of sale device 104, the VWS 102, the transaction server 100 and the store server 118. The purchaser's payment card particulars, and specifically payment number, is stored in the VWS 102 and is communicated only from the VWS 102 to the transaction server 100 either directly or via the point of sale device 104 and optionally via both the point of sale device 104 and via the store server 118.

It is appreciated that the terms ‘user,’ ‘customer’ and ‘purchaser’ are sometimes used interchangeably in the above description.

It will be appreciated by persons skilled in the art that the present invention is not limited by what has been particularly shown and described hereinabove. Rather the scope of the present invention includes both combinations and subcombinations of the various features described hereinabove as well as modifications thereof which are not in the prior art.

1. A payment system comprising:
a transaction server;
a virtual wallet server (VWS);
at least one point of sale device including a secure element and being operative to provide secure data communication of a purchaser wallet personal identification number (WPIN), but not purchaser payment particulars, to at least said VWS; and
at least one mobile communicator communicating a mobile communicator presence indicator (MCPI) but neither said purchaser WPIN nor said purchaser payment particulars to said at least one point of sale device.

2. A payment system according to claim 1 and wherein said at least one mobile communicator stores neither said purchaser WPIN nor said purchaser payment particulars.

3. A payment system according to claim 1 and wherein said at least one mobile communicator neither reads, writes, communicates nor stores either said purchaser WPIN or said purchaser payment particulars.

4. A payment system according to claim 1 and wherein said at least one point of sale device is capable of receiving said purchaser WPIN at said secure element and receiving said MCPI for card presence verification for carrying out a card present transaction with said VWS.

5. A payment system according to claim 2 and wherein said at least one point of sale device is capable of receiving said purchaser WPIN at said secure element and receiving said MCPI for card presence verification for carrying out a card present transaction with said VWS.

6. A payment system according to claim 3 and wherein said at least one point of sale device is capable of receiving said purchaser WPIN at said secure element and receiving said MCPI for card presence verification for carrying out a card present transaction with said VWS.

7. A payment system according to claim 1 and also comprising:
at least one customer purchases information (CPI) database containing customer-wise information regarding customer purchases; and
at least one customer-wise purchase proposal generation device (CPPGD) in data communication with said at least one CPI database, said at least one CPPGD including:
a customer-wise information interface (CWII) receiving from said at least one CPI database said customer-wise information regarding customer purchases;
a customer-wise products not purchased calculator (CWPPC) operative to ascertain the identity of at least one product which is normally purchased by customers and which is not usually purchased by a specific customer from a given sales entity; and
a purchase proposal generation engine (PPGE) generating an individualized purchase proposal for said at least one product which is normally purchased by customers and which is not usually purchased by said specific customer from said given sales entity to said specific customer based on said customer-wise information regarding customer purchases.

8. A payment system according to claim 1 and wherein:
said VWS is operative in conjunction with a plurality of payment modalities and is operative to automatically select one of said plurality of payment modalities for a given transaction, based on at least identity of a customer and identity of a merchant.

9. A payment system according to claim 1 and wherein:
said VWS is operative in conjunction with a plurality of payment modalities; and
said at least one point of sale device provides to said VWS at least data identifying a specific merchant and a specific purchase,
said VWS being operative prior to completion of a specific transaction to recommend to a customer about to complete the transaction one of said plurality of payment modalities for said specific transaction between said specific merchant and a specific customer for said specific purchase at a specific time; based on at least one of:
identity of said specific customer;
identity of said specific merchant;
particulars of said specific purchase; and
the time.

10. A payment system comprising:
a transaction server;
a virtual wallet server (VWS);
at least one point of sale device including a secure element and being operative to provide secure data communication of a purchaser wallet personal identification number (WPIN) to at least said VWS; and
at least one mobile communicator communicating at least one mobile communicator presence indicator (MCPI) but storing neither said purchaser WPIN nor said purchaser payment card number.

11. A payment system comprising:
a transaction server;
a virtual wallet server (VWS);
at least one point of sale device including a secure element and being operative to provide secure data communication of a purchaser wallet personal identification number (WPIN) to at least said VWS; and
at least one mobile communicator communicating at least one mobile communicator presence indicator (MCPI) but neither reading, writing, communicating nor storing either said purchaser WPIN or said purchaser payment card number.

12. A payment system comprising:
a virtual wallet server (VWS);
at least one point of sale device including a secure element enabling secure data communication with said VWS; and
at least one mobile communicator capable of communicating a mobile communicator presence indicator (MCPI) to said at least one point of sale device;
said at least one point of sale device being capable of receiving a purchaser identifier at said secure element and receiving said MCPI for card presence verification for carrying out a card present transaction with said VWS.

13. A payment system according to claim 12 and wherein said at least one mobile communicator does not require a secure element for communicating said MCPI.

14. A payment system according to claim 12 and wherein said at least one mobile communicator does not include a secure element for communicating said MCPI.

15. A payment system according to claim 12 and wherein said MCPI includes at least one of a user selected identifier, a phone number of said at least one mobile communicator, an international mobile subscriber identity (IMSI) of said at least one mobile communicator, an international mobile equipment identity (IMEI) of said at least one mobile communicator and a randomly generated temporary mobile subscriber identity (TMSI) of said at least one mobile communicator.

16. A payment system according to claim 15 and wherein said TMSI is received by and stored in said at least one mobile communicator.

17. A payment system according to claim 15 and wherein said TMSI is received by said at least one mobile communicator from said VWS via a wireless system.

18. A customer identity and product identity offer generation system comprising:
at least one customer purchases information (CPI) database containing customer-wise information regarding customer purchases; and
at least one customer-wise purchase proposal generation device (CPPGD) in data communication with said at least one CPI database, said at least one CPPGD including:
a customer-wise information interface (CWII) receiving from said at least one CPI database said customer-wise information regarding customer purchases;
a customer-wise products not purchased calculator (CWPPC) operative to ascertain the identity of at least one product which is normally purchased by customers and which is not usually purchased by a specific customer from a given sales entity; and
a purchase proposal generation engine (PPGE) generating an individualized purchase proposal for said at least one product which is normally purchased by customers and which is not usually purchased by said specific customer from said given sales entity to said specific customer based on said customer-wise information regarding customer purchases.

19. A payment system comprising:
a virtual wallet server (VWS) operative in conjunction with a plurality of payment modalities; and
at least one point of sale device in data communication with said VWS and providing at least data identifying a specific merchant and a specific purchase,
said VWS being operative prior to completion of a specific transaction to recommend to a customer about to complete the transaction one of said plurality of payment modalities for said specific transaction between said specific merchant and a specific customer for said specific purchase at a specific time; based on at least one of:
identity of said specific customer;
identity of said specific merchant;
particulars of said specific purchase; and
the time.
